(19) United States
(12) Patent Application Publication
(10) Pub. No.: US 2018/0236456 A1
(43) Pub. Date: Aug. 23, 2018

(54) Seal For A Comminution Apparatus

(71) Applicant: FLSmidth A/S, Valby (DK)

(72) Inventors: Jason Daubert, Northampton, PA (US); William Wentzel, Bethlehem, PA (US); Alan Cloak, Emmaus, PA (US); Kurt Geiger, Danielsville, PA (US)

(21) Appl. No.: 15/752,940

(22) PCT Filed: Sep. 7, 2016
(86) PCT No.: PCT/US2016/050525

§ 371 Date: Feb. 15, 2018

Related U.S. Application Data
(60) Provisional application No. 62/215,765, filed on Sep. 9, 2015.

(51) Int. Cl. B02C 15/04; B02C 23/00; F16J 15/32

(52) U.S. Cl. CPC B02C 15/04; F16J 15/32; B02C 23/00

(57) ABSTRACT

A comminution apparatus can include a seal that is configured to interface with a lip seal defined adjacent to sidewall of a housing adjacent to a lever connected to a roller located inside the housing. The lever may extend from the roller within the housing to a position outside of the housing and pass through a seal attached to the housing. The seal can be configured to include a first annular member configured for attachment to the housing adjacent to the lever and a lip seal attached to a housing sidewall adjacent the lever. A second annular member may be attached to the first annular member outside of the housing adjacent a portion of the lever. A deformable annular member may be attached between the first and second annular members and may be deformable to a plurality of different configurations in response to motion of the lever.

### CROSS-REFERENCE OF RELATED APPLICATIONS

This application is an international application which claims the benefit of U.S. Provisional Patent Application No. 62/215,765 filed on 9 Sep. 2015.

### FIELD

The present innovation relates to devices configured to comminute material, such as mills, presses, grinding devices, or other types of comminution apparatuses and seals for such devices.

### BACKGROUND

Mills, presses, crushers, and other types of comminution devices used to grind material often include a crushing body or multiple crushing bodies that are configured to impact material to comminute the material. Examples of such comminution devices and seals used in such devices may be appreciated from U.S. Pat. Nos. 84,978, 252,755, 1,225,061, 1,519,989, 1,589,302, 1,965,186, 3,833,273, 3,955,766, 3,964,717, 4,339,086, 4,369,926, 4,456,267, 4,485,974, 4,582,260, 5,203,513, 5,823,450, and 6,523,767 and German Patent Publication No. DE 102008022847.

Comminution devices often require significant electricity consumption for their operation. This is particularly true when an air flow is used to help convey material inside the device, to facilitate the comminution of the material fed to the device, and/or to help facilitate the output of comminuted material from the device. For instance, fan operations for some types of mills can incur an operating expense of 1-2 million U.S. dollars in electricity costs for the use of a fan in one year of operation of the comminution device.

Often, ambient air from outside the housing leaks into the device housing that is used to retain material as it is crushed or otherwise comminuted during operation of the device. The ingress of ambient false air can increase the electricity needed during operation of a comminution device as the fan can be required to operate at a higher intensity due to the draw of additional air that occurs in the housing of the comminution device. The increased power draw incurs a significant operational cost to the operator of the comminution device. In some situations, the air loss or false air draw can be so significant that it requires a larger fan or other type of air flow driving mechanism than would otherwise be needed, which increases the initial capital costs associated with this device to the operator of the device.

### SUMMARY

A comminution apparatus, a seal for the comminution apparatus, a plant that includes the comminution apparatus, and methods related to use and manufacture of the seal, the comminution apparatus, and the plant are provided herein.

Embodiments of the comminution apparatus can be configured to include a housing configured to enclose a first crushing body, a first moveable lever connected to the first crushing body such that a portion of the first lever extends out of a first opening defined in a first sidewall of the housing, and a first annular deformable seal attached to the housing adjacent to the first lever such that a portion of the first lever is positioned in an opening of the seal. The seal can be configured to be deformable into a plurality of different positions when the lever is moved to adjust a position of the first crushing body.

Embodiments of a seal for a housing of a comminution apparatus that is positionable adjacent to a lever that passes through an opening of the housing for attachment to a roller positioned in the housing can include a first member that is configured to be attached to the housing adjacent the opening, a second member that is configured to be positioned outside of the housing, and a deformable member connected between the first and second members. First, second, and third apertures defined in the first member, second member, and deformable member can be aligned such that a portion of the lever is positionable within the first, second, and third apertures. The first deformable member can be deformable from a collapsed position to a plurality of different extended positions in which at least one portion of the deformable member is extended from a collapsed state. The deformable member can also be configured to enclose the portion of the lever that is positionable in the third aperture and deform in response to motion of the lever.

A method of retrofitting a comminution apparatus can include providing a deformable seal and installing the seal about an opening of a housing of a comminution apparatus such that a portion of a lever of the comminution apparatus is within an opening of the seal defined by the first, second, and third apertures of the seal adjacent to the opening of the housing of the comminution apparatus through which the lever passes into the housing for connection to a comminution body. The installation of the seal can occur such that the lever is not removed from the comminution apparatus or positioned out of the opening of the housing during the installing of the seal.

Embodiments of the plant can be configured to include an embodiment of the comminution apparatus. The plant may also include at least one fluid flow driving mechanism. Material to be crushed may be fed from a source of material to the comminution apparatus. The comminution apparatus can be configured to output comminuted material to another plant process device for use of that comminuted material.

Other details, objects, and advantages of the invention will become apparent as the following description of certain exemplary embodiments thereof and certain exemplary methods of practicing the same proceeds.

### BRIEF DESCRIPTION OF THE DRAWINGS

Exemplary embodiments of the comminution apparatus, a seal for the comminution apparatus, and methods of making the same are shown in the accompanying drawings. It should be understood that like reference numbers used in the drawings may identify like components.

FIG. 1 is a schematic view of a first exemplary embodiment of a comminution apparatus.

FIG. 2 is a fragmentary schematic view of the first exemplary embodiment of a comminution apparatus.

FIG. 3 is a fragmentary schematic view of the first exemplary embodiment of a comminution apparatus that illustrates an exemplary seal included in the apparatus.

FIG. 4 is a fragmentary perspective view of the first exemplary embodiment of a comminution apparatus that illustrates the exemplary seal included in the apparatus

FIG. 5 is a cross sectional view of the first exemplary embodiment of a comminution apparatus shown in FIG. 4.

FIG. 6 is a schematic view of the exemplary seal included in the first exemplary embodiment of the comminution apparatus. Releasable attachment mechanisms 22 that may be included in the exemplary seal are illustrated in hashed line and chain line in FIG. 6.

FIG. 7 is a block diagram illustrating an exemplary embodiment of the comminution apparatus within an exemplary embodiment of a plant.

### DETAILED DESCRIPTION OF EXEMPLARY EMBODIMENTS

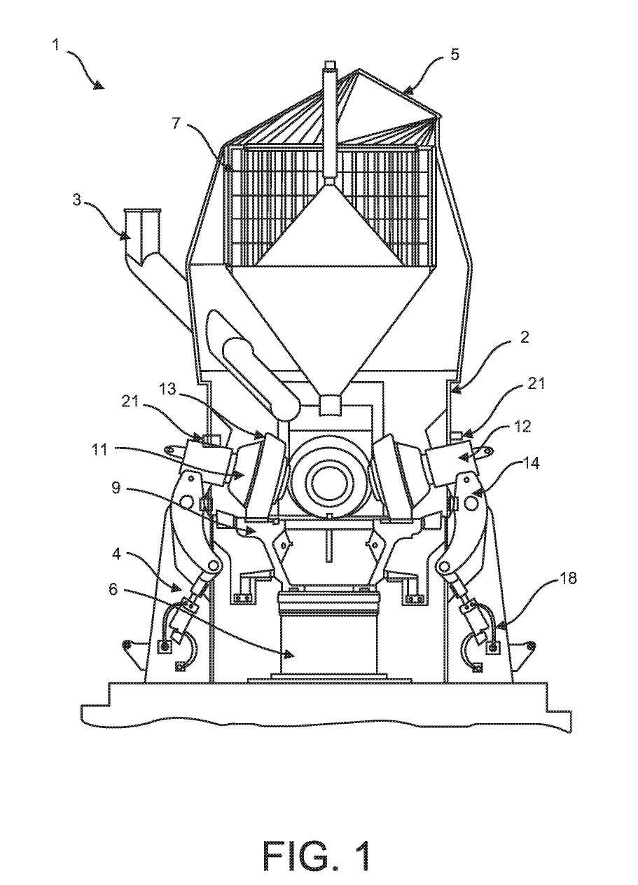

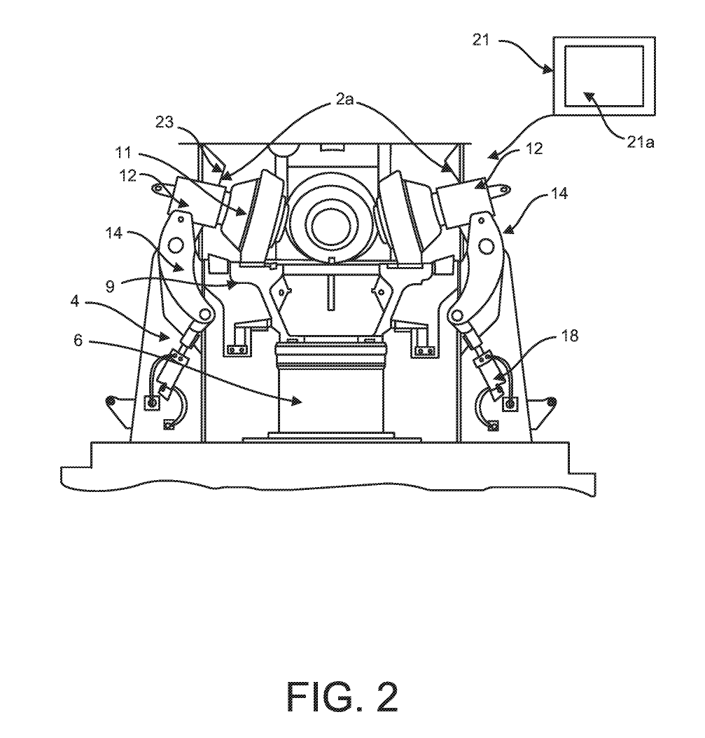

Referring to FIGS. 1-2 and 7, a comminution apparatus 1 can be configured as a roller mill. The roller mill may be configured as a vertical roller mill in some embodiments. In other embodiments, it is contemplated that the comminution apparatus may be configured as another type of mill or other type of comminution device in which at least one crushing body is adjustably positionable relative to a grinding surface for the comminution of material via a lever or a type of articulated linkage system that may include one or more components external to a housing in which the comminution of the material occurs. The comminution apparatus may be configured to comminute a material such as a mineral, an ore, rock, stone, agglomerated material, cement clinker, cement raw meal, or other type of material.

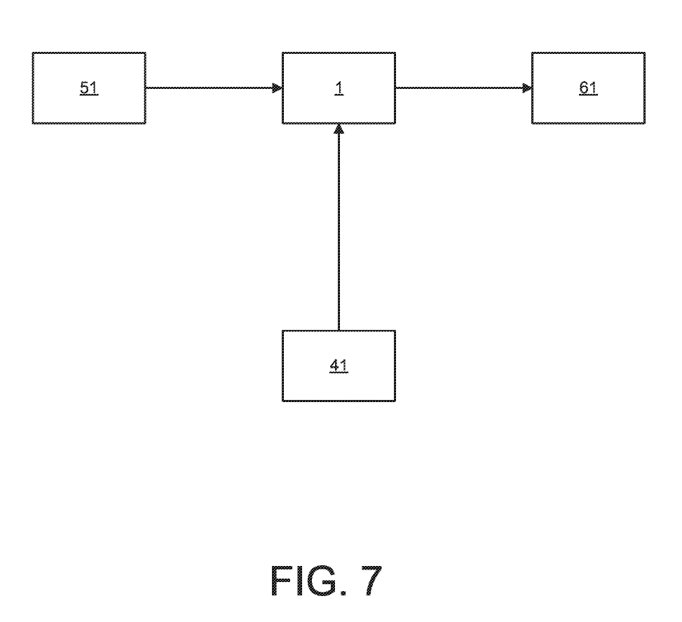

The comminution apparatus 1 can include a feed duct 3 that is in fluid communication with a vessel that retains material or other source of material 51 so that the material is feedable to the comminution apparatus 1 via the feed duct 3. The material may be solid material such as particulate material within a pre-selected size range that is to be comminuted via the comminution apparatus 1 to a smaller size and subsequently output to another process device 61 of a plant for use of the comminuted material. The plant shown in FIG. 7 that includes the comminution apparatus 1 may be a cement manufacturing plant or may be another type of plant, such a mineral processing plant or another type of plant in which a material is to be crushed to a smaller size by the comminution apparatus 1 for use in at least one other plant process or for use in transporting the material to another location in the plant or away from the plant.

A fluid flow driving mechanism 41 such as a fan, a blower, or a pump can be connected to the housing 2 of the comminution apparatus to help facilitate the conveying of material into the housing 2, comminution of the material and/or output of comminuted material. For instance, the fluid flow driving mechanism 41 can be coupled to the housing 2 to facilitate the conveying of comminuted material to a separator 7 that may be located above one or more crushing bodies that are moved for comminution of the material. For example, the fluid flow driving mechanism 41 can provide fluid such as air or other type of gas into the housing 2 of the comminution apparatus so that material within a pre-selected size range is conveyed to a separator 7 and subsequently output from the housing 2 via output opening 5 of the housing. As another example, the fluid flow driving mechanism 41 can provide a vacuum by drawing a flow of fluid out of the housing 2 to help facilitate the flow of material out of the housing 2 via the output opening 5.

The separator 7 can be positioned adjacent one or more crushing bodies 11 of the comminution apparatus and the output opening 5 to receive the comminuted material and prevent material that is larger than a pre-selected size range from being output from the output opening 5. For example, the separator 7 can be configured to sort the material from the crushing bodies 11 so that material that is too large is returned to the crushing bodies for further comminution while material within a pre-selected size range is able to be output from the separator 7 through the output opening 5 of the housing.

The crushing bodies 11 of the comminution apparatus can be positioned within the housing 2 below the separator 7 and be configured to be rotated or otherwise moved to impact material adjacent a grinding surface that may be defined on a grinding table 9 or other type of grinding body. In some embodiments, each of the crushing bodies 11 may be a roller that is rotated about a respective lever 12. Each lever 12 may be vertically and or horizontally adjustable to adjust a position of the crushing body 11 relative to the grinding surface defined by the grinding table 9 via a linkage system that may include a member 14 that is moveable via an actuator 18.

In some embodiments, the lever 12 may be configured as a rocker arm lever or other type of linkage component of a linkage system. For instance, the lever 12 can extend from the crushing body 11 positioned inside the housing to a moveable member 14 that is pivotally connected to the lever 12 outside of the housing and is also pivotally connected to at least one actuator 18. Each lever 12 may extend from outside the housing to inside the housing by passing through an opening 2a defined in the housing 2. For instance, a first lever may pass through a first opening 2a, a second lever 12 may pass through a second opening 2a, a third lever 12 may pass through a third opening 2a and a fourth lever 12 may pass through a fourth opening 2a. Each lever 12 may be attached to a respective crushing body 11 (e.g. first lever 12 attached to a first crushing body 11, second lever 12 attached to a second crushing body 11, third lever 12 attached to a third crushing body 11, a fourth lever 12 attached to a fourth crushing body 11, a fifth lever 12 attached to a fifth crushing body 11 and a sixth lever 12 attached to a sixth crushing body 11) within the housing 2.

The actuator 18 can include at least one hydraulic cylinder or other type of actuator that is moveable to adjust a position of the crushing body 11 within the housing 2 via motion of the member 14 and lever 12 pivotally connected to the member 14. The member 14 may be pivotally connected to the housing 2 and/or to a stand 4 that supports the housing 2. The stand 4 may include one or more legs or a base that rests on the ground or supports the housing on the ground, on a platform such as a concrete platform or other type of platform structure. In some embodiments, the member 14 can be configured as a rocker arm fork that is pivotally connected adjacent to an outer first end of lever 12. The inner second end of the lever 12 that is opposite the outer first end may be positioned inside the housing 2 and be connected to a crushing body 11.

A main drive reducer 6 can be connected to the grinding table 9 and be positioned under the grinding table 9 to help support the grinding table 9. The main drive reducer may also be configured to facilitate vertical adjustment of the position of the grinding table 9 within the housing 2 and/or rotational movement of the grinding table 9 that may be actuated to facilitate comminution of the material on the grinding surface of the grinding table 9 in combination with rotation of the crushing bodies 11.

In some embodiments, the crushing bodies may each have a tire 13 or other type of annular tire element 13 attached around a perimeter portion of the body that is configured to engage the grinding table or a bed of material on the grinding table so that rotation of the grinding table 9 also drives rotation of the crushing body 11 about the axle defined by the lever 12 attached to that crushing body 11. In other embodiments, rotation of the crushing bodies 11 is driven by rotation of roller shafts that are coupled to the levers 12 and/or integrated into the levers 12 for coupling the levers 12 to the crushing bodies 11. For instance, each lever 12 may be coupled to a respective roller shaft for attaching the crushing body 11 to that lever 12 such that the crushing body 11 is rotatable about the roller shaft to rotate relative to the rotating grinding table 9. In some embodiments, the axes of rotation of the grinding table 9 may be a vertical axis while the axis of rotation of each crushing body may be a substantially horizontal axis as defined by an angle at which the lever 12 extends into the housing to the crushing body 11 (e.g. a horizontal axis, an axis that is 60-90 degrees relative to the vertical axis, etc.).

The main drive reducer 6 may be positioned below the housing between legs of the stand 4 that may engage the ground or a concrete platform. The main driver reducer may be at least partially outside of the housing 2 in some embodiments or may be fully outside of the housing and have its upper end attached to a bottom end of a body of the grinding table 9.

Rotation of the grinding table 9 and the crushing bodies 11 during comminution operations can result in the comminution of the material fed into the housing 2 via the feed duct 3. An air flow or other type of gaseous fluid may be driven into the housing 2 via a fluid driving mechanism 41 fluidly connected to the housing 2 to help facilitate the driving of comminuted material to the separator 7 for being output the output opening 5 of the housing 2 when the material has been crushed to a size that is within a pre-selected size range.

A rubbing lip seal 23 may be attached to the housing or defined in the housing 2 adjacent to each opening 2a. Each lip seal 23 can be configured to block material from passing out of the opening 2a of housing 2 to which that lip seal 23 is adjacent. There may be a lip seal 23 defined in the housing adjacent each opening 2a or attached to the housing adjacent each opening 2a (e.g. a respective lip seal for a respective one of the openings 2a such that there is a first lip seal 23 defined adjacent a first opening 21a through which a first lever 12 is positioned, a second lip seal 23 defined adjacent a second opening 21a through which a second lever 12 is positioned, a third lip seal 23 defined adjacent a third opening 21a through which a third lever 12 is positioned, a fourth lip seal 23 defined adjacent a fourth opening 21a through which a fourth lever 12 is positioned, a fifth lip seal 23 defined adjacent a fifth opening 21a through which a fifth lever 12 is positioned, and a sixth lip seal 23 defined adjacent a sixth opening 21a through which a sixth lever 12 is positioned).

In addition to each lip seal 23, a deformable seal 21 can be positioned adjacent each opening 2a and can be configured to provide an air-tight seal or a substantially air-tight seal on the housing 2 adjacent opening 2a so a gas passed into the housing 2 does pass into the housing 2 via openings 2a (e.g. prevents a significant amount of air from being draw into the housing via opening 2a or prevents all air from being drawn into the housing 2 via opening 2a). Each deformable seal 21 can have an opening 21a that is sized and configured so that a lever 12 is positionable in the opening 21a so that a portion of the lever is within the opening 21a when a first end of the lever is attached to a crushing body 11 and a second end of the lever 12 that is opposite its first end is outside the housing 2 and attached to member 14. A respective deformable seal 21 can be provided for a respective one of the openings 2a for being positioned around a portion of the lever passing through that opening 2a to provide an air-tight seal. (e.g. a first deformable seal 21 may be attached to the housing 2 adjacent a first lever 12 positioned through a first opening 2a, a second deformable seal 21 may be attached to the housing 2 adjacent a second lever 12 positioned through a second opening 2a, a third deformable seal 21 may be attached to the housing 2 adjacent a third lever 12 positioned through a third opening 2a, a fourth deformable seal 21 may be attached to the housing adjacent a fourth lever 12 positioned through a fourth opening 2a, a fifth deformable seal 21 may be attached to the housing adjacent a fifth lever 12 positioned through a fifth opening 2a, and a sixth deformable seal 21 may be attached to the housing adjacent a sixth lever 12 positioned through a sixth opening 2a).

Each deformable seal 21 can be configured so that a deformable member 21c of the deformable seal 21 can be removed and replaced without having to remove the lever 12 or member 14 and without having to rotate the lever 12 or member 14 out of the housing 2. For instance, after the deformable seal 21 is installed around a lever 12 adjacent an opening 2a, the deformable member 21c of the deformable seal 21 may be disconnected from the deformable seal 21 and replaced with a new deformable member 21c without having to remove other parts of the deformable seal 21 and without having to adjust a position of the lever 12 out of the housing 2 or out of opening 2a in which the lever 12 is positioned.

Each deformable seal 21 can be configured to be collapsible and expandable so that the seal is deformable into different positions or orientations in response to adjustment of the position of the lever 12 that may be driven via motion of actuator 18 and motion of member 14 that is driven by actuator 18 to adjust the position of a crushing body 11 to which the lever 12 is attached.

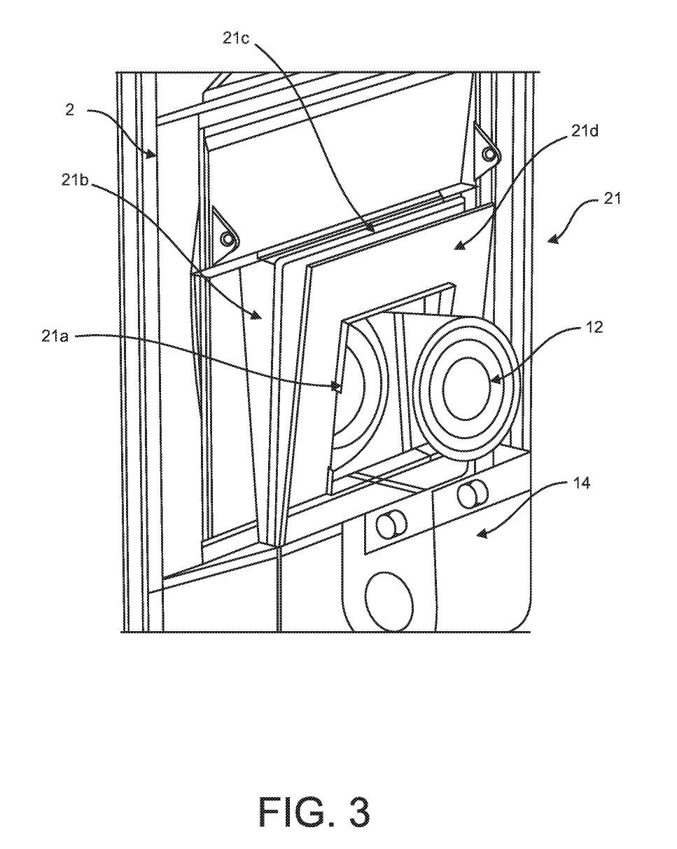

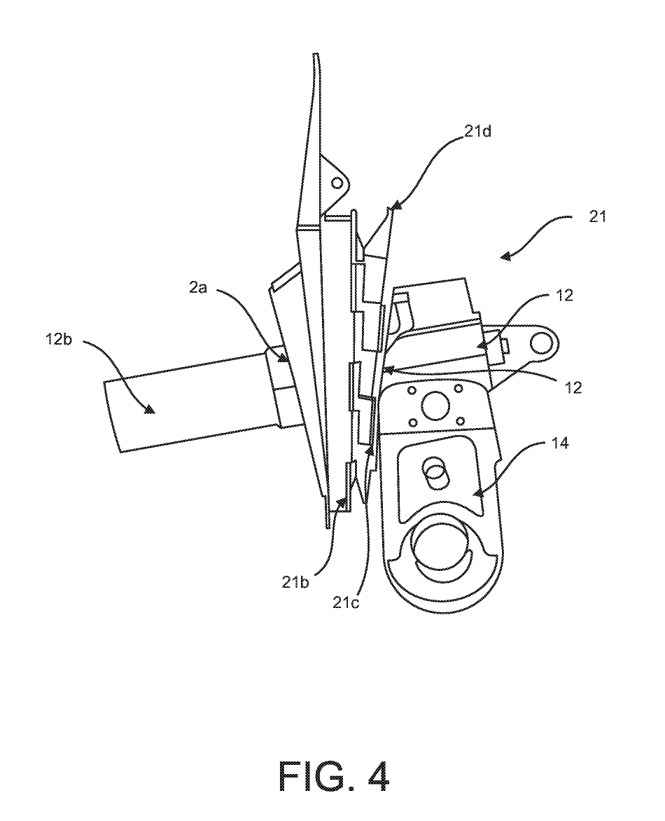

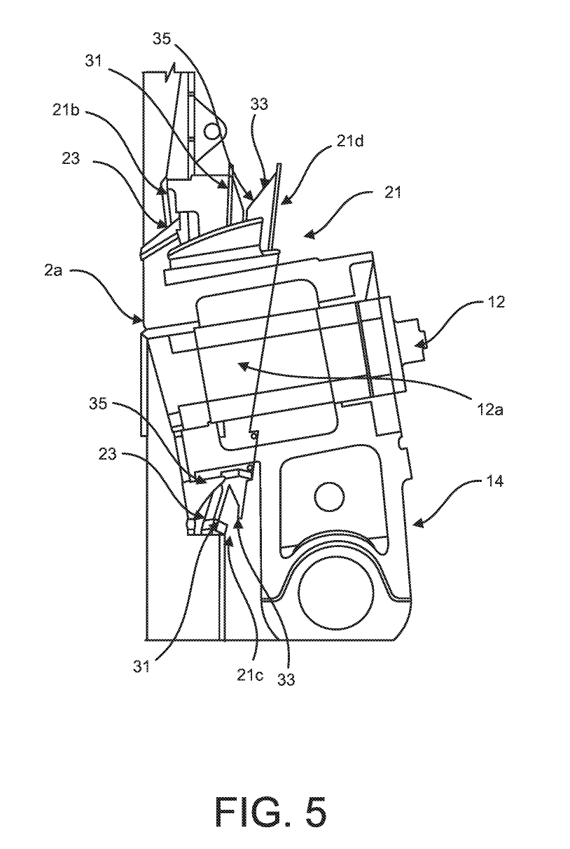

Referring to FIGS. 3-6, embodiments of the deformable seal 21 can include a first plate member 21b that is sized and configured to be attached to the housing 2 adjacent opening 21a and the lip seal 23 that is positioned adjacent that opening 2a. The first plate member 21b can have an annular shape that has a polygonal, circular, elliptical, or other shape with a central first aperture defined therein. The first plate member 21b can be configured to be fastened to the housing 2 via fasteners, and/or welding or other fastening mechanism adjacent to an opening 2a. A second plate member 21d can be positioned adjacent to the lever and be located outside of the housing 2. The second plate member 21d can be an annular shaped member that has a polygonal, circular, elliptical, or other shape with a central second aperture defined therein. The second plate member 21d can be spaced apart from the first plate member 21b by a deformable member 21c connected between the first and second plate members 21b and 21d. The deformable member 21c may be composed of a deformable material such as rubber, vulcanized rubber, or other type of elastomeric material. In other embodiments, the deformable material of the deformable member can be a fabric material, a type of woven material, or a type of deformable non-woven material that is supported by tensioning of the material by deformable arms or springs that are configured to hold the fabric material in place adjacent opening 2a. For such embodiments, the arms or springs may be attached to the first plate member 21b or other structure adjacent the opening 2a.

The second plate member 21d can be fastened to the deformable member 21c via fasteners or other type of fastening mechanism. The second plate member 21d can be configured so that when it is fastened to the deformable member 21c, it functions as a seal cap to seal the outer side of the deformable member 21c that is opposite the side of the deformable member attached to the first plate member 21b.

The deformable member 21c may be annular in shape and have a third central aperture defined therein. In some embodiments, the deformable member 21c may be structured to have a polygonal shape, circular shape, elliptical shape, a tapered shape or other type of shape. For instance, the deformable member may be generally tubular in shape or have a tapered shape that defines an inner aperture such as a channel, passageway, or other type of opening.

The first, second, and third apertures of the first and second plate members 21b and 21d and the deformable member 21c can be aligned with each other and in communication with each other to define the opening 21a of the deformable seal 21. A first portion 12a of the lever 12 may be positioned in the opening while a second portion 12b of the lever is located inside the housing 2 as the lever extends along its length from the member 14 outside of the housing to the crushing body 11 inside the housing 2.

The deformable member 21c can be configured as a bellows or have a shape similar to a bellows to help facilitate collapsing and extending of the deformable member to provide for adjustment in the configuration of the deformable member in response to motion of the lever 12 that may occur from repositioning of the crushing body 11 that is driven by motion of actuator 18 attached to member 14. The deformation of the deformable member 21c can permit the deformable member to move from a collapsed position or collapsed state to a number of different partially extended positions and a fully extended position such that the distance at which the second plate member 21d is spaced apart from the first plate member 21b may change as the deformable member 21c deforms in response to adjustment of the positioning of the lever 12.

In some embodiments, the deformable member 21c can be configured to compress during adjustment of a position of the lever 12 or may extend during adjustment of a position of the lever 12. The compression of the deformable member 21c may occur when the lever is adjusted in a first instance to compress the deformable member 21c to a more compressed state when the lever 12 is moved to a first new position so that the deformable member 21c has a shorter length when deformed to the first new position. Thereafter, another adjustment of the position of the lever 12 to a second new position may result in an extension of the deformable member 21c occurring as the lever is moved to that second new position so that the deformable member 21c is extended to a greater length than its length in the first new position.

It is also contemplated that the deformable member 21c can be configured so that a portion of the deformable member compresses while another portion of the deformable member extends when a position of lever 12 is changed. For instance, the deformable member can be configured so that a lower side becomes more compressed while an upper side becomes more extended to accommodate motion of lever 12 and subsequently deform in response to other motion of lever 12 so that the upper side becomes more compressed while the lower side become more extended. As another example, left and rights sides of the deformable member may be configured to further collapse in response to motion of the lever and/or further extend in response to motion of the lever as the upper and lower sides of the member compress or extend. The compression or extension of different sides of the deformable member may be configured to occur in a non-uniform way. For instance, an upper rights side of the deformable member may be less compressed than a lower right side of the deformable member due to motion of the lever 12 while the upper or lower sides are generally uniformly compressed or expanded. As another example, the upper left side of the deformable member may be further compressed than an upper right left side of the deformable member 21c when the lever 12 is moved to a particular position.

The deformable member 21c can include a plurality of first deformable elements 31 and second deformable elements 33. Each first deformable element 31 may extend from its first end that contacts the first plate member 21b inwardly from the first plate member 21b to its inner second end. Each second deformable element may extend from its first end that contacts the second plate member 21d to its second inner end. The second inner ends of the first and second deformable elements may be integrally connected at a junction 35. The deformation of the deformable member 21c may occur via deformation of the first and second deformable elements 31 and 33 about the junctions 35. In some embodiments, the first and second deformable elements 31 and 33 may be integral portions of the same member.

The deformable member 21c may also be structured so that a first portion of the deformable member 21c is splittable from another portion so that the deformable member 21c may be removed from around the lever 12 without having to adjust a position of the lever 12 or move the lever 12 out of the housing to replace the deformable member 21c if it becomes damaged. In some embodiments, removal of the deformable member 21c can be configured so that the second plate member 21d is also removable from around the lever 12 when the deformable member is removed. In other embodiments, the second plate member 21d may be configured so that it is not be removed when the deformable member 21c is removed.

In some embodiments, one or more of the releasable attachment mechanisms 22 can be positioned in or defined in the deformable member so that two or more parts of the deformable member are connectable to form an integral single part by adjustment of each releasable attachment mechanism 22 to its closed position for forming a deformable bellows seal that is also disconnectable into multiple parts (e.g. two parts, three parts, four parts, etc.) by adjusting the one or more releasable attachment mechanisms to their open positions to facilitate removal of the deformable member 21c from around the lever 12. In yet other embodiments, there may be only one releasable attachment mechanism 22 that is configured to be moved to an open position to define a gap or slit in the deformable member 21c so that the deformable member may be moved away from the lever 12 via that slit or gap when the releasable attachment mechanism is in its open position.

For example, the deformable member 21c may have a releasable attachment mechanism 22 positioned on opposite sides of the member that is adjustable from a connected position to a disconnected position to form one or two slits in the deformable member 21c so that two parts of the deformable member may be disconnected and moved away from each other. In some embodiments, the releasable attachment mechanism can be configured as a zipper structure.

For instance, first releasable attachment mechanisms 22a can be positioned on opposite first and second sides of the deformable member 21c or defined in opposite first and second sides of the deformable member 21c. As another example, second releasable attachment mechanisms 22b can be positioned on opposite third and fourth sides of the deformable member 21c or defined in opposite third and fourth sides of the deformable member 21c.

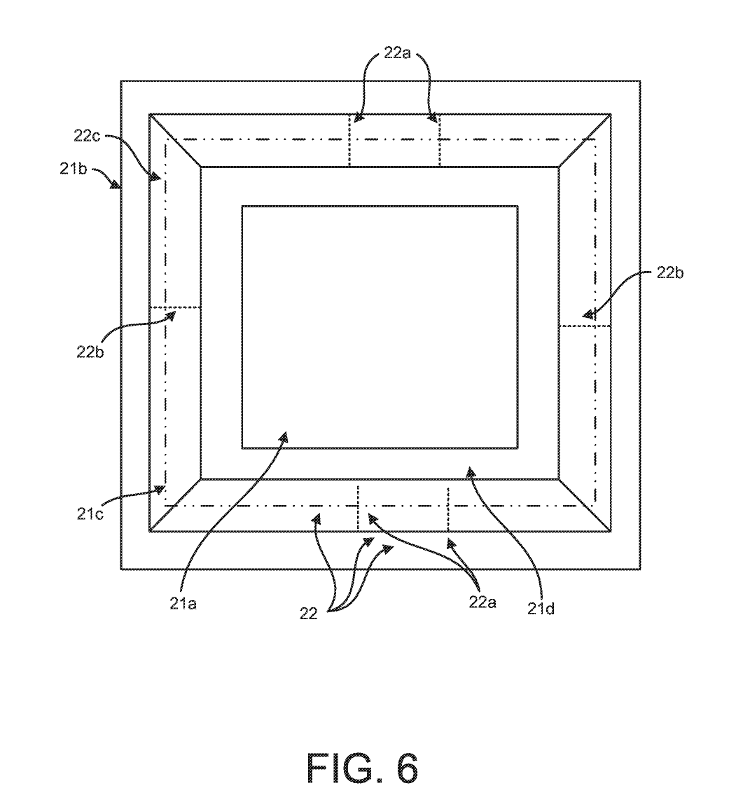

As yet another alternative, only a single releasable attachment mechanism may be positioned or defined in one side of the deformable member 21c so that when the releasable attachment mechanism is positioned to an open configuration the deformable member 21c has a slit defined therein where the releasable attachment mechanism is located so that the deformable member is moveable to remove the deformable member 21c from around the lever 12 without having to adjust the position of the lever by rotating it out of the housing 2. For example, only one of the first releasable attachment mechanism 22a or only one of the second releasable attachment mechanisms 22b may be positioned or defined on a side of the deformable member. As yet another alternative, it is contemplated that that a single third releasable attachment mechanism may be positioned on or defined in the deformable member 21c such that the releasable attachment mechanism extends along a perimeter of the annular structure of the deformable member as shown in chain line in FIG. 6.

As yet another example, the releasable attachment mechanism 22 can be configured so that there are two parallel regions along the upper side and/or lower side of the deformable body that may be released from each other to create a gap or slit through which the deformable member may be moved away from the lever 12. In yet other embodiments, the two parallel regions may be on the left and/or right sides of the deformable member 21c.

The deformable member 21c can be configured to be attached to the first plate member 21b by screws, bolts, or other type of fastener elements and can be configured to be attached to the second plate member 21d by screws, bolts or other type of fastener element. The use of such fasteners can permit the deformable member 21c to be removably attached to the first and second plate members 21b and 21d without having to remove the first and/or second plate members 21b and/or 21d. The use of the releasable attachment mechanism 22 can then permit the separated deformable member 21c that is separated by at least one releasable attachment mechanism 22 to be removed from around the lever 12 without having to move the lever 12 out of the housing 2. This can greatly reduce the need for downtime when performing maintenance on the deformable seal 21 or in replacing the deformable member 21c of the deformable seal 21 that may be needed due to wear.

In other embodiments, it is contemplated that the releasable attachment mechanism 22 may be defined by a chemical bonding of elastomeric material or vulcanizing of that material. For instance, a first portion and a second portion of the deformable member can be chemically bonded together at one or more locations along a length, width, or height of the deformable member to define locations at which the deformable member is to be integrally attached during installation after those parts are positioned around a lever 12. This way, the lever 12 need not be moved during the installation process. After the chemical bonding is formed and installation is finished, the chemical bond at these locations of chemical bonding may then be broken to separate the parts of the deformable member 21c for removal of the deformable member 21c from around the lever 12 when it is needed to be replaced by a new deformable member 21c due to wear or damage so that such maintenance can be performed without the lever 12 having to be moved or without a crushing body 11 attached to the lever having to be significantly moved.

Embodiments of the deformable seal can be configured for installation or retrofitting onto an embodiment of the comminution apparatus. For example, the first plate member 21b may be welded or otherwise attached to the housing 2 adjacent opening 2a. In some embodiments, the lever 12 may be rotated out of the housing 2 for the attachment of the first plate member 21b. In other embodiments, the first plate member 21b may be attached to the housing in parts to facilitate the installation of the first plate member 21b without having to move the lever 12 or rotate the lever 12 out of the housing 2. At least one releasable attachment mechanism 22 of the deformable member 21c may be positioned into its open position so that the deformable member may be attached to the first plate without having to move the lever out of the housing 2. A first side of the deformable member 21c may then be attached to the first plate member 21b via fasteners such as bolts or screws. The second plate member 21d may then be fastened via fasteners to the second side of the deformable member opposite the first side that is attached to the first plate. The second plate member 21d may be attached to define a seal cap on the outer side of the deformable member 21c. Each attachment mechanism 22 of the deformable member 21c may be moved to its closed position before the second plate member 21d is attached to the second side of the deformable member 21c or may be moved to its closed position after the second plate member 21d is attached to the second side of the deformable member 21c.

After installation of the deformable seal, the deformable member 21c may experience wear and need to be replaced. The deformable member 21c can be replaced by adjusting the one or more releasable attachment mechanisms 22 to an open position and unfastening first and second sides of the deformable member 21c (e.g. front and rear sides) from the first and second plate members 21b and 21d. A new deformable member 21c may then be positioned around the lever 12 by having its one or more releasable attachment mechanisms in an open position and thereafter positioning the lever 12 in the third aperture of the deformable member 21c. The new deformable member 21c may then be fastened to the first and second plate members 21b and 21d and have its one or more releasable attachment mechanisms adjusted to a closed position. The replacement of the deformable member 21c may occur without any change in position of the lever 12 being needed and without the lever 12 having to be moved out of the housing 2.

Each deformable seal 21 can be configured to work in conjunction with the lip seal 23 adjacent that deformable seal 21. Alternatively, the deformable seal 21 may be used without the rubbing lip seal 23 in place.

For embodiments utilizing a lip seal 23, the lip seal 23 can be configured to function to prevent material passing out of opening 2a while the deformable seal 21 can provide a seal adjacent the opening to prevent false air from passing into the housing via operation of the fan, blower, pump, compressor, or other type of fluid flow driving mechanism 41 that is in communication with the housing. For vertical roller mill applications, it is contemplated that the air tight seal or substantially air tight seal provided by the deformable seal member 21 can provide a reduction in electricity usage by as much as 6% for operation of a fluid flow driving mechanism 41 as compared to conventional vertical roller mills by preventing false air from passing into housing 2 via openings 2a. It is contemplated that some embodiments may even provide more than a 6% reduction in electricity usage required for a fluid flow driving mechanism 41 by preventing false air from being drawn into the housing 2 via openings 2a. Such a reduction can permit smaller sized fluid flow driving mechanisms 41 to be used and/or to have pre-existing such mechanisms operate at a lower power draw, which can save substantial costs to an operator.

For example, in some conventional vertical roller mills, ingress of false air from outside the mill can be substantial. In some conventional devices, an ingress of false air of up to 25% occurs. It is contemplated that use of an embodiment of the deformable seal being installed on such a device could help prevent the drawing in of a substantial quantity of ambient false air (if not completely prevent the drawing in of false air) and reduce electricity usage by 20-25%.

The prevention of false air ingress into the housing 2 via openings 2a or a substantial reduction in the amount of false air ingress into the housing 2 can equate to a substantial cost savings to an operator of the comminution apparatus. For instance, it is contemplated that an embodiment of the comminution apparatus may be operated such that there is a decrease of $60,000 to $120,000 in electricity costs as compared to a conventional device due to the prevention of at least a substantial amount of false air ingress. A substantial reduction in the drawing in of false air or the prevention of the drawing in of false ambient air can also increase potential production of the comminution apparatus as compared to a conventional device. A lowering of operating costs and increase in production may therefore be provided by embodiments of the comminution apparatus 1.

Embodiments of the deformable seal 21 may also be retrofitted onto pre-existing devices. It is contemplated that such retrofitting may help an operator of a conventional device experience a decrease in electricity costs of $60,000 to $120,000 per year of operation. In some pre-existing installations that may experience a drawing in of false ambient air of about 25%, the operational savings that may be provided by embodiments of the deformable seals 21 may be even be more dramatic (e.g. may be between about $200,000 U.S. to about $500,000 U.S. in operational cost savings to an operator).

It should be appreciated that embodiments of the comminution apparatus, plant having the comminution apparatus, deformable seal, and method of making and using the same can be modified to meet different sets of design criteria. For instance, the size and shape of the first plate member, deformable member and second plate member of the deformable seal 21 can be any of a number of different shapes to meet a particular design objective. The material composition of the first and second plate members 21b and 21d may also be a number of different materials, such as metal, alloy, or other type of material as may be needed to meet a particular design criteria. As yet another example, the fastening mechanism used to releaseably connect the first and second plate members 21b and 21d to the deformable member 21c can be any type of such fastening mechanism such as bolts, screws, or other type of such mechanism. As yet another example, the size of the different elements of the comminution apparatus 1 and the comminution apparatus 1 may be any number of sizes to meet a particular set of design criteria that may take into account desired operational parameters. As yet another example, it is contemplated that the comminution apparatus can be configured as a vertical roller mill or may be configured as another type of comminution device or other type of mill. As yet another example, each crushing body 11 may be configured as a roller or as another type of crushing body, such as a roller press body, an impactor body, or other type of comminution body. As yet another example, in some embodiments it is contemplated that one or more deformable seals 21 can be provided to prevent air loss from the housing instead of having the deformable seals prevent false air from being inadvertently fed into the housing 2 as false air via openings 2a. It should be understood that the arrangement of the fluid flow driving mechanism 41, feed duct 3, crushing bodies 11, and output opening 5 can dictate whether the deformable seals 21 function to prevent false air from being drawn into the housing via openings 2a or prevent air loss.

While certain exemplary embodiments of the comminution apparatus, plant, seal for the comminution apparatus, and methods of making and using the same have been shown and described above, it is to be distinctly understood that the invention is not limited thereto but may be otherwise variously embodied and practiced within the scope of the following claims.

What is claimed is:

1. A comminution apparatus comprising:
a housing configured to enclose a first crushing body;
a first moveable lever connected to the first crushing body, a portion of the first lever extending out of a first opening defined in a first sidewall of the housing; and
a first annular deformable seal attached to the housing adjacent to the first lever, a portion of the first lever positioned in an opening of the seal, the seal being deformable into a plurality of different positions when the lever is moved to adjust a position of the first crushing body.

2. The comminution apparatus of claim 1, comprising:
a lip seal attached to the first sidewall or defined in the first sidewall adjacent to the first opening, the lip seal configured to prevent material from passing out of the first opening of the housing.

3. The comminution apparatus of claim 2, wherein the first annular seal is configured to engage the lip seal to prevent air from passing out of the housing via first opening of the housing or passing into the housing via the first opening of the housing.

4. The comminution apparatus of claim 1, wherein the first annular seal comprises:
a first member that is configured to be attached to the first sidewall adjacent the first opening of the housing, the first member having a first central aperture;
a second member that is configured to be positioned outside of the housing, the second member having a second central aperture; and
a deformable member connected between the first and second members, the deformable member having a third central aperture, the first deformable member being deformable from a collapsed position to a plurality of different extended positions in which at least one portion of the deformable member is extended from a collapsed state, the deformable member configured to enclose a portion of the lever that passes through the first opening and deform in response to motion of the lever.

5. The comminution apparatus of claim 4, wherein the deformable member is configured as a bellows.

6. The comminution apparatus of claim 4, wherein the deformable member is comprised of a plurality of integrally connected bellow members that extend between the first and second members to enclose a portion of the lever that passes through the first, second, and third apertures.

7. The comminution apparatus of claim 6, wherein the first opening is at least partially defined by the first, second, and third apertures.

8. The comminution apparatus of claim 4, wherein the deformable member comprises:
a first set of first deformable elements, each of the first deformable elements extending from the first member inwardly toward the portion of the lever within the first opening; and
a second set of second deformable elements, each of the second deformable elements extending from the second member inwardly toward the portion of the lever within the first opening;
each second deformable element has an inner distal end that is connected to an inner distal end of a respective first deformable element at a junction such that the first and second deformable elements deform about the junction.

9. The comminution apparatus of claim 8, wherein the junction integrally connects the first deformable element to the second deformable element.

10. The comminution apparatus of claim 4, wherein the deformable member has a releasable attachment mechanism defined in the deformable member that is adjustable from a first position in which the deformable member defines a full annular structure that encloses the lever to a second position in which at least one slit is defined in the deformable member to facilitate disconnection of the deformable member from around the lever.

11. A seal for a housing of a comminution apparatus that is positionable adjacent to a lever that passes through an opening of the housing for attachment to a roller positioned in the housing, the seal comprising:
a first member that is configured to be attached to the housing adjacent the opening, the first member having a first aperture;
a second member that is configured to be positioned outside of the housing, the second member having a second aperture; and
a deformable member connected between the first and second members, the deformable member having a third aperture,
the first, second, and third apertures being aligned such that a portion of the lever is positionable within the first, second, and third apertures; and
the first deformable member being deformable from a collapsed position to a plurality of different extended positions in which at least one portion of the deformable member is extended from a collapsed state, the deformable member configured to enclose a portion of the lever that is positionable in the third aperture and deform in response to motion of the lever.

12. The seal of claim 11, wherein the deformable member comprises:
first deformable elements, each of the first deformable elements extending from the first member inwardly toward the portion of the lever within the first opening; and
second deformable elements, each of the second deformable elements extending from the second member inwardly toward the portion of the lever within the first opening; and
each second deformable element has an inner distal end that is connected to an inner distal end of a respective first deformable element at a junction such that the first and second deformable elements deform about the junction.

13. The seal of claim 12, wherein each junction integrally connects the first inner distal end of the first deformable element to the second inner distal end of the second deformable element.

14. The seal of claim 11, wherein the deformable member has at least one releasable attachment mechanism defined in the deformable member that is adjustable from a first position in which the deformable member defines a full annular structure that encloses the lever to a second position in which at least one slit or gap is defined in the deformable member to facilitate disconnection of the deformable member from around the lever.

15. A method of retrofitting a comminution apparatus comprising:
providing the seal of claim 11;
installing the seal about an opening of a housing of a comminution apparatus such that a portion of a lever of the comminution apparatus is within an opening of the seal defined by the first, second, and third apertures adjacent to the opening of the housing of the comminution apparatus through which the lever passes into the housing for connection to a comminution body; and
wherein the installing of the seal occurs such that the lever is not removed from the comminution apparatus or positioned out of the opening of the housing during the installing of the seal.
